(19) United States
(12) Patent Application Publication
(10) Pub. No.: US 2020/0099830 A1
(43) Pub. Date: Mar. 26, 2020

(54) MOUNTING CAMERA SYSTEM TO ELECTRONIC DEVICE

(71) Applicant: Google LLC, Mountain View, CA (US)

(72) Inventor: Valentin de la Fuente, San Jose, CA (US)

(21) Appl. No.: 16/138,183

(22) Filed: Sep. 21, 2018

(51) Int. Cl. H04N 5/225; G03B 17/02

(52) U.S. Cl. CPC H04N 5/2254; G03B 17/02; H04N 5/2252

(57) ABSTRACT

A camera system includes: a housing that accommodates a camera unit, the housing having a first mounting surface and a second mounting surface; and a coverglass for the camera unit, the coverglass mounted to the housing at the first mounting surface; wherein the second mounting surface is configured for mounting the camera system to an inside of a device housing so that the coverglass is positioned in an opening of the device housing.

### TECHNICAL FIELD

This document relates, generally, to mounting a camera system to an electronic device.

### BACKGROUND

Cameras are nowadays a common feature of some types of electronic devices such as smartphones and tablets. Some device types have multiple cameras installed, and can have one camera that is directed toward the user when the user is facing a device screen (sometimes referred to as a “front” camera) and another camera that is oppositely directed from the device screen (sometimes referred to as a “rear” camera).

Various form factors of digital electronic devices have been developed in the past. Some device manufacturers may prioritize device features differently than other manufacturers, resulting in their devices having different characteristics than those of its competitors. This can be a valuable differentiator in the marketplace if customers find the characteristic an attractive feature.

### SUMMARY

In a first aspect, a camera system includes: a housing that accommodates a camera unit, the housing having a first mounting surface and a second mounting surface; and a coverglass for the camera unit, the coverglass mounted to the housing at the first mounting surface; wherein the second mounting surface is configured for mounting the camera system to an inside of a device housing so that the coverglass is positioned in an opening of the device housing.

Implementations can include any or all of the following features. The housing further comprises an annular member that forms at least part of the first and second mounting surfaces. The second mounting surface is recessed toward the camera unit from the first mounting surface. The first and second mounting surfaces form a common plane. The second mounting surface comprises one or more flanges configured for mounting the camera system to the inside of the device housing. Multiple flanges are positioned symmetrically about a periphery of the housing. Each of the plurality of flanges has a rectangular shape. The camera system further comprises an adhesive at the first mounting surface that attaches the coverglass to the first mounting surface. The adhesive also covers at least part of the second mounting surface for attaching the camera system to the device housing. The adhesive comprises an annular film.

In a second aspect, an electronic device comprises: a device housing having an opening; and a camera system mounted to an inside surface of the device housing, the camera system comprising: a housing that accommodates a camera unit, the housing having a first surface and a second surface; and a coverglass for the camera unit, the coverglass mounted to the housing at the first surface; wherein the camera system is attached to an inside of the device housing at the second surface so that the coverglass is positioned in the opening of the device housing.

Implementations can include any or all of the following features. The first and second surfaces form a common plane. The electronic device further comprises first adhesive applied to the first surface to attach the coverglass to the housing, and second adhesive applied to the second surface to attach the camera system to the inside surface. The first and second adhesives comprise an annular film. The coverglass has a tolerance to the opening in the device housing. The first surface is provided with a plurality of flanges configured for mounting the camera system to the inside of the device housing. The first surface is formed by an annular flange of the housing. The annular flange is concentric with, and has a smaller diameter than, the opening in the device housing.

In a third aspect, a method includes: assembling a camera system comprising a housing that accommodates a camera unit; attaching a coverglass to a first surface of the housing; and attaching the camera system to an inside surface of a device housing having an opening, the housing of the camera system having a second surface configured for positioning the camera system at the inside surface so that the coverglass is positioned in the opening of the device housing.

Implementations can include the following feature. Attaching the coverglass and attaching the camera system comprise applying an adhesive to the first and second surfaces, the adhesive comprising an annular film.

### BRIEF DESCRIPTION OF DRAWINGS

FIG. 1 shows an example of a camera housing.

FIG. 2 shows an example of a camera system including the camera housing of FIG. 1.

FIG. 3 shows a cross-section of an example of an electronic device having a camera system.

FIG. 4 shows another example of a camera system.

FIG. 5 shows another example of a camera housing.

FIG. 6 shows an example of a method of assembling an electronic device.

FIG. 7 shows an example of a computer device and a mobile computer device that can be used to implement the techniques described here.

Like reference symbols in the various drawings indicate like elements.

### DETAILED DESCRIPTION

This document describes examples of camera systems for electronic devices. In some implementations, a camera system can have one or more mounting features integrated into a housing of the camera system. For example, including such a camera system in the design can allow the electronic device (e.g., the housing of the electronic device) to be made thinner.

Some device manufacturers are currently prioritizing device thinness more than what may have been done in some earlier generations of products. Designing and manufacturing a thinner device can be challenging for multiple reasons, for example due to problems with applying existing approaches for incorporating the camera(s) in the device. Some existing designs of smartphones and tablets, however, incorporate cameras in a way that may not be optimized for device thinness. Such designs may place a rear camera against the inside of the device enclosure, with the enclosure having an opening for light to be received by the camera. A stackup in such approaches can include a rear camera module having a camera, a cosmetic or protective cover lens for the camera, and the portion of the enclosure surrounding the opening. In such a stackup, the rear camera module is sometimes mounted to a lip that is present inside the opening in the enclosure. Such a lip may be machined out of the metal material of the enclosure, by an operation performed from one side of the enclosure. For example, the manufacturing process can involve forming a passage through the wall of the enclosure, and widening the passage, from the outside of the housing, to have a diameter greater than the diameter of the opening. The widened passage at the outside of the enclosure does not extend through the entire thickness of the wall but may be only deep enough to accommodate the cosmetic lens. The result of such a machining process is a lip within the opening. When the stackup is assembled, the rear camera module can be mounted onto the lip from inside the enclosure, and the cosmetic lens can be mounted to the lip from the outside of the enclosure so as to cover the passage. An adhesive layer is placed between the camera module and the inside surface of the lip, and another adhesive layer is placed between the cosmetic lens and the outside surface of the lip.

The thickness of the rear camera module can be a driving factor for total thickness of the product. Some existing devices may have a noticeable “bump” on their housing to accommodate the thickness of the rear camera. The above-mentioned approach involving a lip may place restrictions on the product thinness that can be achieved. The combined thicknesses of the lip and the two layers of adhesive, all of which thicknesses are cumulative and do not overlap with each other in the stackup, can amount to a considerable portion of the overall thickness of the device. Eliminating or reducing the thickness associated with mounting of a camera module can therefore allow the device to be made thinner.

The apparatuses or techniques described or exemplified herein can provide significant advantages. In some implementations, mounting features can be integrated into the body of the camera system itself so that a coverglass can be mounted directly to the camera housing. The housing can be bonded directly to the inside of the housing of the device. Such approaches can eliminate significant height (e.g., thickness) from the stackup of the camera, thereby allowing for a thinner design of the device. For example, mounting surfaces for the coverglass and for the camera housing itself can be integrated into the camera housing for a slimmer design. For example, the entire thickness of a lip machined into the wall of the enclosure can be eliminated. As another example, only a single layer of adhesive may be needed, leading to further space saving.

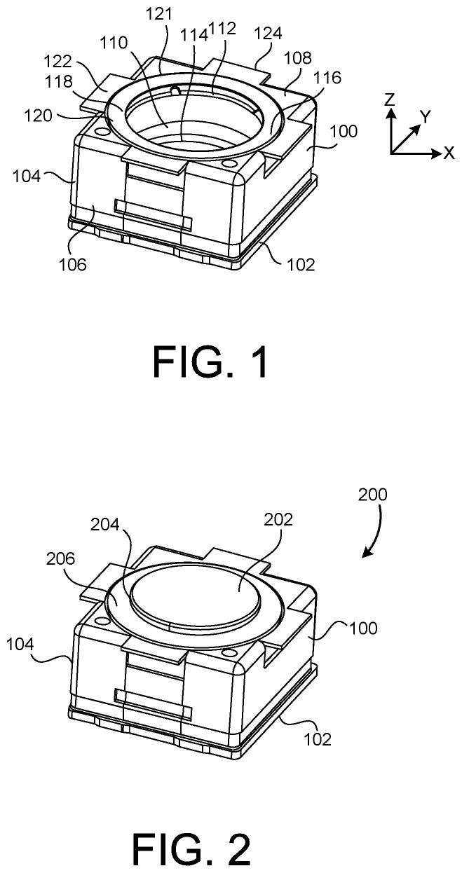

FIG. 1 shows an example of a camera housing 100. The camera housing 100 can be used with one or more other examples described herein. In some implementations, the camera housing 100 can be installed in a housing or enclosure of a smartphone or a tablet. For example, the camera housing 100 can be used to provide a rear camera in such an implementation. The word “rear” in this or other examples is merely a relative term that is used only for illustrative purposes and does not necessarily imply a particular orientation or direction. In some implementations, the camera housing 100 can be used with a front camera.

The camera housing 100 can be made from one or more materials. In some implementations, the camera housing 100 includes a polymer material. For example, at least part of the camera housing 100 can be manufactured in an injection molding process. In some implementations, the camera housing 100 includes metal. For example, the camera housing 100 can be cast, machined and/or stamped from metal stock, into a suitable design.

The camera housing 100 includes a base 102 and a body 104. The word “base” in this or other examples is merely a relative term that is used only for illustrative purposes and does not necessarily imply a particular orientation or direction. The base 102 can be a substantially flat component that can hold some or all electronics or other circuitry for the camera housing 100. For example, the base 102 can hold an image sensor, processing circuitry, and a flex circuit connection into the camera housing 100 as part of incorporating a camera unit. Such a camera unit is omitted in the present illustration for simplicity and will be exemplified below. The body 104 can be configured for at least partially enclosing the camera unit and thereby protecting the camera unit during the assembly process and in the finished product. The base 102 and the body 104 can be coupled to each other in any of multiple ways. In some implementations, an adhesive and/or at least one fastener is used.

The body 104 can have one or more walls 106. The wall(s) 106 can be substantially perpendicular to the base 102. In some implementations, the walls 106 are arranged so that the body 104 has a square or otherwise rectangular shape. Here, the body 104 has a face 108 that is substantially perpendicular to the walls 106. The face 108 and the wall(s) 106 can be made as an integrated unit, for example by machining or in a molding process. The face 108 and the wall(s) 106 can be attached to each other using a suitable fastener depending on the material(s) of the face 108 and the wall(s) 106.

A cavity 110 can be formed in part of the inside of the camera housing 100. In some implementations, the body 104 defines a substantially empty passage between an end 112 that is adjacent the face 108, and an end 114 that is adjacent the base 102. The cavity 110 can then include the substantially empty passage as closed off by the base 102 at the end 114. The cavity 110 can hold at least one camera component of the camera housing 100, including, but not limited to, a lens, an image sensor, and/or processing circuitry. The opening of the cavity 110 that is adjacent the end 112 can be designed to serve as a light inlet for the camera unit to allow it to capture images.

A Cartesian coordinate system having respective x-, y- and z-axes is here shown with the camera housing 100 for purposes of explanation. The x- and y-axes define a plane that is substantially parallel with the orientation of the base 102 in the present exemplary illustration. For example, the length and width of the camera housing 100 can be defined by the dimensions of the base 102 and the body 104 as measured relative to the x- and y-axes. The z-axis, moreover, is here parallel to the plane of the drawing. Accordingly, a height of the camera housing 100 (sometimes referred to as its thickness) can be defined by the dimensions of the base 102 and the body 104 as measured relative to the z-axis. Depending on the orientation of the camera housing 100 when installed in a device, the z-axis in the present example may correspond to the direction between the front (e.g., the display) and the rear (e.g., the back of the enclosure) of the device. In other words, the ability of the camera housing 100 to facilitate the making of a thinner electronic device can in part depend on the height of the camera housing 100 along the z-axis. It can therefore be advantageous that the camera housing 100 provides space saving at least in the z-direction. Examples of such features are described below.

The camera housing 100 includes an annular member 116. In some implementations, the annular member 116 is part of the body 104. For example, the annular member 116 can be an integral component of the body 104 and located at the face 108. The annular member 116 can form an annular flange, for example as shown. The annular member 116 can include one or more surfaces that can provide advantages in the assembly of a camera system based on the camera housing 100, and/or in the mounting of such a camera system onto the housing of an electronic device. Here, the annular member 116 includes a surface 118 that extends to the edge where the annular member 116 ends at the opening of the cavity 110. For example, the surface 118 has an annular shape. The surface 118 can be considered a mounting surface, for example as will be described below. Here, the annular member 116 includes a surface 120 that extends from the surface 118 to an edge 121 on the face 108. For example, the surface 120 has an annular shape. The surface 120 can be considered a mounting surface. For example, the surface 120 can be configured for positioning the camera housing 100 with regard to a device housing (e.g., at an inside surface thereof). The surfaces 118 and 120 can form a common plane.

In some implementations, the camera housing 100 can include one or more surfaces that can provide advantages in the mounting of a camera system based on the camera housing 100 onto the housing of an electronic device. The body 104 can include at least one surface 122 that can be considered part of the face 108. The surface 122 can be considered a mounting surface. For example, the surface 122 can be configured for positioning the camera housing 100 with regard to a device housing (e.g., at an inside surface thereof). Here, the surface 122 is formed by a flange 124 that extends from the body 104 adjacent at least one of the walls 106.

The surface 118 and/or the surface 120 can have a different position on the z-axis compared to the surface 122. In some implementations, the surface 118 and/or the surface 120 is recessed from the surface 122 toward the base 102 (e.g., toward the camera unit that in part can be held by the base 102). Such difference in z-position can provide advantages in designing a thinner device, for example as will be described. Here, the surfaces 118 and 120 are both recessed from the surface 122 by the same distance.

The camera housing 100 can include multiple flanges 124. The flange(s) 124 can be configured for mounting a camera system based on the camera housing 100 onto the housing of an electronic device. For example, the flange(s) can increase a footprint of the camera housing 100. In some implementations, the flanges 124 are positioned symmetrically about a periphery of the camera housing 100. Here, the camera housing 100 has one of the flanges 124 positioned at each of the walls 106, and the flange 124 is positioned substantially in the center of the width of the respective wall 106. The flanges 124 are therefore positioned symmetrically about the periphery of the face 108 in the present example. Here, the flange 124 extends substantially in the x-y plane as indicated, and can be substantially parallel with the general extension of the base 102. The flanges 124 can have the same or different shapes. Here, the flange 124 has substantially a rectangular shape as extending past the respective wall 106.

FIG. 2 shows an example of a camera system 200 including the camera housing 100 of FIG. 1. The camera system 200 can be used with one or more other examples described herein. Components described with reference to FIG. 1 that are not explicitly mentioned can serve the same or a similar purpose in the camera system 200.

The camera system 200 is shown in an assembled state where a camera unit (not shown) has been included in the camera housing 100, for example such that at least part of the camera unit is contained within the cavity 110 (FIG. 1). As part of the assembly, a coverglass 202 having an edge 204 has been mounted to the camera housing 100. Here, an adhesive 206 is visible beyond the edge 204 of the coverglass 202. The adhesive 206 may be placed on the surface 118 and/or the surface 120 (FIG. 1). For example, the adhesive 206 can attach the coverglass 202 to the surface 118 (FIG. 1). The portion of the adhesive 206 that is presently visible can be used for one or more other purposes, including, but not limited to, for mounting the camera system 200 to the housing of an electronic device.

The coverglass 202 can serve as a cosmetic and/or protective lens for the camera unit that is included in the camera system 200. In some implementations, the coverglass 202 may provide no or only insignificant refraction of the light being captured by the camera. Rather, the camera can include one or more optically effective lenses responsible for conditioning the light beam for receipt by an image sensor. In some implementations, the coverglass 202 can exclude or may not be a lens. In some implementations, the coverglass 202 can have two planar surfaces. In some implementations, the coverglass 202 is substantially planar across an entirety of a lens of the camera. In some implementations, the coverglass 202 does not significantly refract light toward the camera. The coverglass 202 can be manufactured from glass material. For example, the coverglass 202 can include hardened glass similar to the type sometimes used to provide a touchscreen on an electronic device. The coverglass 202 can have any shape that is compatible with the particular implementation. For example, the coverglass 202 can be a circular member that has a rectangular profile (e.g., the coverglass 202 can have a solid cylindrical shape).

The adhesive 206 can include one or more of a variety of adhesive materials. The adhesive 206 can include a synthetic and/or natural adhesive material. In some implementations, the adhesive 206 includes a pressure-sensitive adhesive (PSA). The adhesive 206 can have a liquid form, a solid form, or a semi-solid form when applied to the camera housing 100. In some implementations, the adhesive 206 has an annular form (e.g., as a ring). The adhesive 206 in a solid form can be provided as a foil of adhesive material. For example, the adhesive 206 is here an annular film applied to the body 104 of the camera housing 100.

The camera system 200 is an example of a camera system that includes a housing (e.g., the camera housing 100) that accommodates a camera unit, the housing having a first mounting surface (e.g., the surface 118 in FIG. 1) and a second mounting surface (e.g., the surface 120 and/or 122 in FIG. 1). The camera system includes a coverglass (e.g., the coverglass 202) for the camera unit, the coverglass mounted to the housing at the first mounting surface. The second mounting surface is configured for mounting the camera system to an inside of a device housing (e.g., by way of the portion of the adhesive 206 extending outside the edge 204 of the coverglass 202) so that the coverglass is positioned in an opening of the device housing.

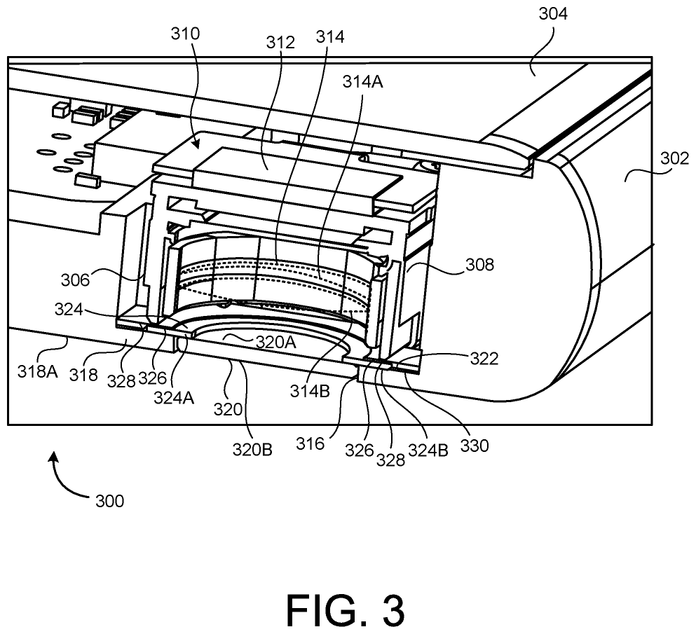

FIG. 3 shows a cross-section of an example of an electronic device 300 having a camera system. The electronic device 300 can be used with one or more other examples described herein. Components corresponding to those described elsewhere herein can serve the same or a similar purpose in the electronic device 300.

Due to the cross-sectional view, not the entire electronic device 300 is visible in the illustration. Also, some components are omitted in the illustration for clarity. The electronic device 300 can be a smartphone, a tablet, a laptop, a display monitor, or a wearable device, to name just a few examples. Here, the electronic device 300 includes a device housing 302 that can serve as the main enclosure for the electronic device 300. For example, the device housing 302 can include metal and/or a compound material such as a polymer plastic. The electronic device 300 has a coverglass 304 mounted to the device housing 302. In some implementations, the coverglass 304 can cover substantially all of a display device (not shown) that may be part of the electronic device 300. For example, the coverglass 304 can provide touchscreen functionality for the electronic device 300.

The electronic device 300 includes a camera system 306 which is here also shown in cross-section. The camera system 306 includes a housing 308 that here has been provided with a camera unit 310. The camera unit 310 can include one or more optically active aspects of the camera system 306. In some implementations, the camera unit 310 includes an image sensor 312. The image sensor 312 can be positioned at, or integrated with, a base of the housing 308 (e.g., compare with the base 102 in FIG. 1). In some implementations, the camera unit 310 includes at least one lens 314, here schematically illustrated using a dashed outline. The lens 314 can have convex surfaces 314A and 314B, of which the convex surface 314A here faces toward the image sensor 312. For example, the lens 314 can be positioned in a cavity defined by the housing 308 so as to direct incoming light toward, and condition the light for being received by, the image sensor 312. The camera unit 310 can also include one or more additional components, including, but not limited to, circuitry for processing image information and/or for communicating with other aspects of the electronic device 300.

The electronic device 300 can have at least one opening 316 in the device housing 302. In some implementations, the opening 316 is configured to permit entry of light to the camera unit 310. The opening 316 can be positioned in any area of the device housing 302. The opening 316 is here formed in a wall 318 that is opposite from the coverglass 304. For example, the opening 316 can be defined by an edge of the wall 318 that is substantially perpendicular to the outer surface of the wall 318. Referring again briefly to the lens 314, the convex surface 314B thereof can face toward the opening 316.

The camera system 306 includes a coverglass 320 for the camera unit 310. The coverglass 320 is mounted to the housing 308. In some implementations, the camera system 306 and the coverglass 320 can be assembled together separately from the device housing 302, and the camera system 306 including the coverglass 320 can then as a unit be mounted to an inside surface 322 of the device housing 302. The coverglass 320 can thereby be positioned in the opening 316 of the device housing 302. A size of the coverglass 320 can be selected based on the dimensions of the opening 316 so that the coverglass 320 has a tolerance to the opening 316. For example, the coverglass 320 and the opening 316 can be substantially circular.

The camera system 306 can include an adhesive 324 that can have any shape. Here, the adhesive 324 has an annular shape. The adhesive 324 can initially be applied to the camera system 306 before the camera system 306 is mounted to the device housing 302. The adhesive 324 abuts the inside surface 322 of the device housing 302. The adhesive 324 also abuts one or more surfaces of the camera system 306. For example, the adhesive 324 abuts a surface 320A of the coverglass 320, the surface 320A here facing toward the inside of the electronic device 300. The coverglass 320 may have been attached to the adhesive 324 after the adhesive 324 was applied to the housing 308. As another example, the adhesive 324 abuts a surface 326 of the housing 308 (e.g., compare with the surface 118 in FIG. 1). The adhesive 324 may have been applied to the surface 326 before the housing 308 was attached to the device housing 302. The surface 326 can be considered a mounting surface. For example, the surface 326 can be configured for positioning the housing 308 with regard to the inside surface 322 of the device housing 302. The adhesive 324 can attach the coverglass 320 to the housing 308 by abutting the surfaces 326 and 320A. As another example, the adhesive 324 abuts a surface 328 of the housing 308 (e.g., compare with the surface 120 in FIG. 1). The adhesive 324 may have been applied to the surface 328 before the housing 308 was attached to the device housing 302. The surface 328 can be considered a mounting surface. For example, the surface 328 can be configured for positioning the housing 308 with regard to the inside surface 322 of the device housing 302. The adhesive 324 can attach the camera system 306 to the device housing 302 by abutting the inside surface 322 and the surface 328. The surfaces 326 and 328 can form a common plane.

A surface 320B of the coverglass 320 is here opposite the surface 320A. For example, the surfaces 320A-B can be parallel to each other. The wall 318 of the device housing 302, moreover, can have an outer surface 318A that is substantially parallel with at least the surface 320B. The surface 320B can be positioned in any of multiple ways relative to the surface 318A. For example, the surface 320B can be essentially co-planar (e.g., flush) with the surface 318A. As another example, the surface 320B can be recessed relative to the surface 318A.

A surface 330 of the housing 308 (e.g., compare with the surface 122 in FIG. 1) is here positioned adjacent the inside surface 322 of the device housing 302. In some implementations, the surface 330 directly contacts the inside surface 322. For example, this can provide a larger footprint for the camera system 306 that is attached to the device housing 302 by the adhesive 324. In some implementations, an adhesive (e.g., part of the adhesive 324 or an adhesive separate from the adhesive 324) is provided between the surface 330 and the inside surface 322.

In this example, the adhesive 324 is an annular film that can be applied to the housing 308 as one unit (e.g., as a single piece of PSA). Other approaches can be taken. In some implementations, multiple portions of adhesive are used for attaching the camera system 306 to the device housing 302. For example, an adhesive 324A can be used to attach the coverglass 320 to the surface 326 of the housing 308. As another example, an adhesive 324B can be used to attach the camera system 306 to the inside surface 322 of the device housing 302.

The electronic device 300 is an example of an electronic device that includes a device housing (e.g., the device housing 302) having an opening (e.g., the opening 316), and a camera system (e.g., the camera system 306) mounted to an inside surface (e.g., the inside surface 322) of the device housing. The camera system includes a housing (e.g., the housing 308) that accommodates a camera unit (e.g., the camera unit 310), the housing having a first surface (e.g., the surface 326) and a second surface (e.g., the surface 328 and/or 330). The camera system also includes a coverglass (e.g., the coverglass 320) for the camera unit, the coverglass mounted to the housing at the first surface. The camera system is attached to the device housing at the second surface so that the coverglass is positioned in the opening of the device housing.

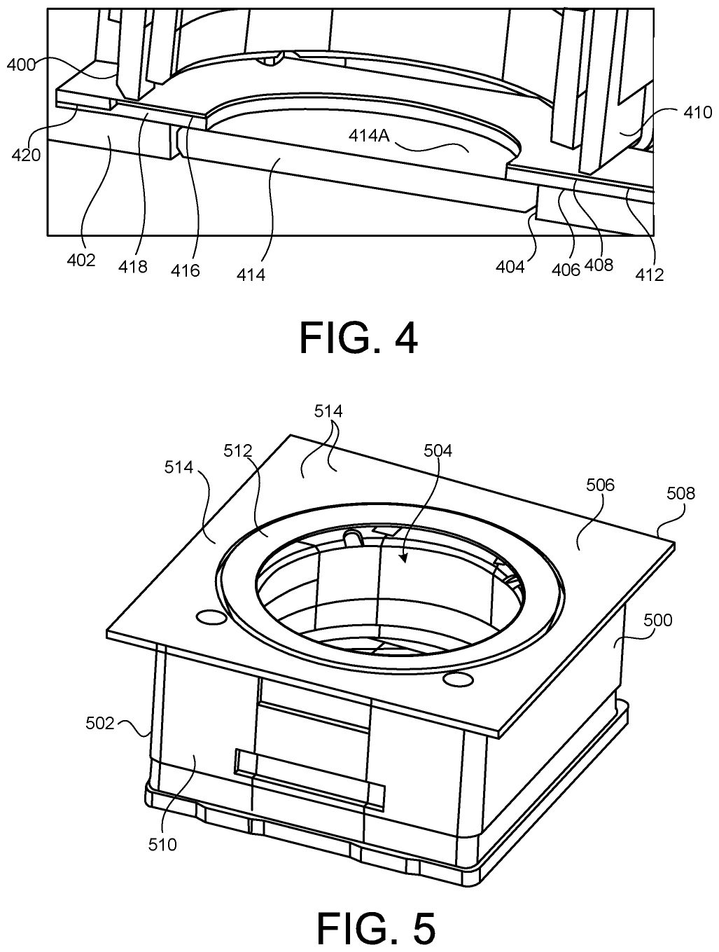

FIG. 4 shows another example of a camera system 400. The camera system 400 can be used with one or more other examples described herein. Components corresponding to those described elsewhere herein can serve the same or a similar purpose in the camera system 400. The camera system 400 is shown in cross-section and some components thereof (e.g., a camera unit) have been omitted for clarity. The camera system 400 is here shown incorporated in an electronic device (e.g., compare with the electronic device 300 in FIG. 3) of which a device housing 402 having an opening 404 is currently visible.

An adhesive 406 is here positioned between, on the one hand, an annular flange 408 of a housing 410 of the camera system 400, and on the other, an inside surface 412 of the device housing 402. Here, the adhesive 406 has an annular shape. The adhesive 406 can initially be applied to the camera system 400 before the camera system 400 is mounted to the device housing 402. The adhesive 406 abuts the inside surface 412 of the device housing 402. The adhesive 406 also abuts one or more surfaces of the camera system 400. For example, the adhesive 406 abuts a surface 414A of a coverglass 414, the surface 414A here facing toward the inside of the electronic device. The coverglass 414 may have been attached to the adhesive 406 after the adhesive 406 was applied to the housing 410. As another example, the adhesive 406 abuts a surface 416 of the housing 410 (e.g., compare with the surface 118 in FIG. 1). The surface 416 can be formed by the annular flange 408. The adhesive 406 may have been applied to the surface 416 before the housing 410 was attached to the device housing 402. The surface 416 can be considered a mounting surface. For example, the surface 416 can be configured for positioning the housing 410 with regard to the inside surface 412 of the device housing 402. The adhesive 406 can attach the coverglass 414 to the housing 410 by abutting the surfaces 416 and 414A. As another example, the adhesive 406 abuts a surface 418 of the housing 410 (e.g., compare with the surface 120 in FIG. 1). The surface 418 can be formed by the annular flange 408. The adhesive 406 may have been applied to the surface 418 before the housing 410 was attached to the device housing 402. The surface 418 can be considered a mounting surface. For example, the surface 418 can be configured for positioning the housing 410 with regard to the inside surface 412 of the device housing 402. The adhesive 406 can attach the camera system 400 to the device housing 402 by abutting the inside surface 412 and the surface 418. The surfaces 416 and 418 can form a common plane. The annular flange 408 can be concentric with the opening 404 in the device housing 402. For example, the annular flange 408 can have a smaller diameter than the opening 404.

A surface 420 of the housing 410 (e.g., compare with the surface 122 in FIG. 1) is here positioned adjacent the inside surface 412 of the device housing 402. In some implementations, the surface 420 directly contacts the inside surface 412. For example, this can provide a larger footprint for the camera system 400 that is attached to the device housing 402 by the adhesive 406. In some implementations, an adhesive (e.g., part of the adhesive 406 or an adhesive separate from the adhesive 406) is provided between the surface 420 and the inside surface 412.

FIG. 5 shows another example of a camera housing 500. The camera housing 500 can be used with one or more other examples described herein. Components corresponding to those described elsewhere herein can serve the same or a similar purpose in the camera housing 500. The camera housing 500 can include a body 502 that defines a cavity 504 defined in part by an opening in a face 506 on the body 502. The camera housing 500 can include at least one flange 508. For example, the flange 508 here projects outward from the face 506 and overhangs walls 510 of the body 502. The flange 508 can be configured for mounting a camera system including the camera housing 500 to a device housing. For example, the flange 508 can provide an enlarged footprint for the camera housing 500.

The camera housing 500 can have a surface 512 (e.g., adjacent the opening of the cavity 504) and a surface 514 (e.g., on the flange 508. Either or both of the surfaces 512 and 514 can be considered a mounting surface. For example, the surface 512 and/or 514 can be configured for positioning the camera housing 500 with regard to an inside surface of device housing (not shown).

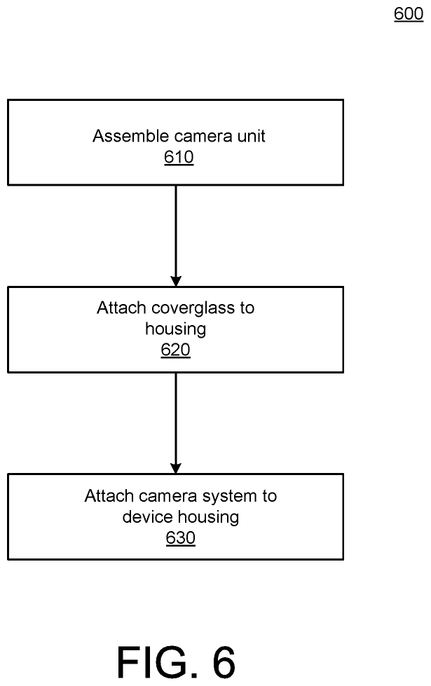

FIG. 6 shows an example of a method 600 of assembling an electronic device. The method 600 can be performed using one or more examples described herein. Some other examples will be mentioned for illustrative purposes. The method 600 can include more or fewer operations than shown. Two or more operations of the method 600 can be performed in another order unless otherwise indicated.

At 610, a camera system can be assembled that includes a housing that accommodates a camera unit. For example, the camera system 306 (FIG. 3) can be assembled at least in part by incorporating the camera unit 310 with the housing 308. For example, the camera system 200 (FIG. 2) can be assembled at least in part by applying the adhesive 206 to the body 104 of the camera housing 100. As another example, the camera system 306 (FIG. 3) can be assembled at least in part by applying the adhesive 324 to the housing 308. As another example, the camera system 400 (FIG. 4) can be assembled at least in part by applying the adhesive 406 to the annular flange 408 of the housing 410. Other measures not described here can be part of an operation of assembling a camera system.

At 620, a coverglass can be attached to a first surface of the housing. For example, the coverglass 202 (FIG. 2) can be attached to the surface 118 (FIG. 1) of the camera housing 100. As another example, the coverglass 320 (FIG. 3) can be attached to the surface 326 of the housing 308. As another example, the coverglass 414 (FIG. 4) can be attached to the surface 416 of the housing 410. The attachment can be done at least in part using adhesive, to name just one example.

At 630, the camera system can be attached to an inside surface of a device housing having an opening. For example, the camera system 306 (FIG. 3) can be attached to the inside surface 322 of the device housing 302 which has the opening 316. As another example, the camera system 400 (FIG. 4) can be attached to the inside surface 412 of the device housing 402 which has the opening 404. The housing of the camera system has a second surface configured for positioning the camera system at the inside surface so that the coverglass is positioned in the opening of the device housing. For example, the camera housing 100 (FIG. 1) can have the surface 120 and/or 122. As another example, the housing 308 can have the surface 328 and/or 330. As another example, the housing 410 (FIG. 4) can have the surface 418 and/or 420. As another example, the camera housing 500 can have the surface 512 and/or 514.

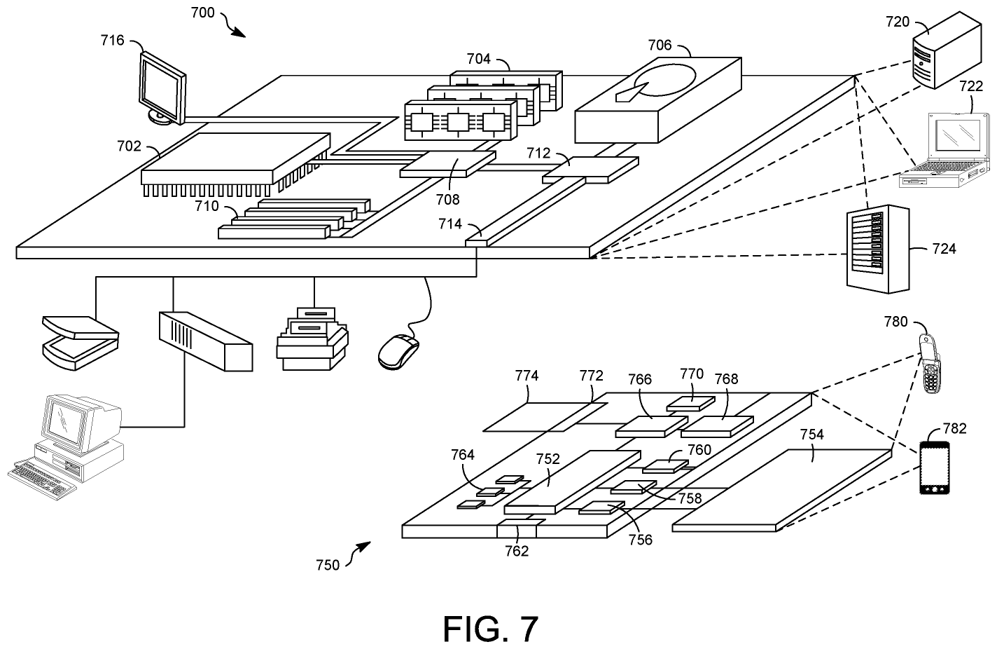

FIG. 7 shows an example of a generic computer device 700 and a generic mobile computer device 750, which may be used with the techniques described here. Computing device 700 is intended to represent various forms of digital computers, such as laptops, desktops, tablets, workstations, personal digital assistants, televisions, servers, blade servers, mainframes, and other appropriate computing devices. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. The processor 702 can be a semiconductor-based processor. The memory 704 can be a semiconductor-based memory. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A camera system comprising:
a housing that accommodates a camera unit, the housing having a first mounting surface and a second mounting surface; and
a coverglass for the camera unit, the coverglass mounted to the housing at the first mounting surface;
wherein the second mounting surface is configured for mounting the camera system to an inside of a device housing so that the coverglass is positioned in an opening of the device housing.

2. The camera system of claim 1, wherein the housing further comprises an annular member that forms at least part of the first and second mounting surfaces.

3. The camera system of claim 2, wherein the second mounting surface is recessed toward the camera unit from the first mounting surface.

4. The camera system of claim 2, wherein the first and second mounting surfaces form a common plane.

5. The camera system of claim 1, wherein the second mounting surface comprises one or more flanges configured for mounting the camera system to the inside of the device housing.

6. The camera system of claim 5, wherein multiple flanges are positioned symmetrically about a periphery of the housing.

7. The camera system of claim 5, wherein each of the plurality of flanges has a rectangular shape.

8. The camera system of claim 1, further comprising an adhesive at the first mounting surface that attaches the coverglass to the first mounting surface.

9. The camera system of claim 8, wherein the adhesive also covers at least part of the second mounting surface for attaching the camera system to the device housing.

10. The camera system of claim 9, wherein the adhesive comprises an annular film.

11. An electronic device comprising:
a device housing having an opening; and
a camera system mounted to an inside surface of the device housing, the camera system comprising:
a housing that accommodates a camera unit, the housing having a first surface and a second surface; and
a coverglass for the camera unit, the coverglass mounted to the housing at the first surface;
wherein the camera system is attached to an inside of the device housing at the second surface so that the coverglass is positioned in the opening of the device housing.

12. The electronic device of claim 11, wherein the first and second surfaces form a common plane.

13. The electronic device of claim 12, further comprising first adhesive applied to the first surface to attach the coverglass to the housing, and second adhesive applied to the second surface to attach the camera system to the inside surface.

14. The electronic device of claim 13, wherein the first and second adhesives comprise an annular film.

15. The electronic device of claim 11, wherein the coverglass has a tolerance to the opening in the device housing.

16. The electronic device of claim 11, wherein the first surface is provided with a plurality of flanges configured for mounting the camera system to the inside of the device housing.

17. The electronic device of claim 11, wherein the first surface is formed by an annular flange of the housing.

18. The electronic device of claim 17, wherein the annular flange is concentric with, and has a smaller diameter than, the opening in the device housing.

19. A method comprising:
assembling a camera system comprising a housing that accommodates a camera unit;
attaching a coverglass to a first surface of the housing; and
attaching the camera system to an inside surface of a device housing having an opening, the housing of the camera system having a second surface configured for positioning the camera system at the inside surface so that the coverglass is positioned in the opening of the device housing.

20. The method of claim 19, wherein attaching the coverglass and attaching the camera system comprise applying an adhesive to the first and second surfaces, the adhesive comprising an annular film.
